(19) United States
(12) Patent Application Publication
(10) Pub. No.: US 2026/0247317 A1
(43) Pub. Date: Aug. 20, 2026

(54) METHODS, ARCHITECTURES, APPARATUSES, AND SYSTEMS FOR WTRU-INITIATED REGISTRATION AT A WIRELESS NETWORK

(71) Applicant: InterDigital Patent Holdings, Inc., Wilmington, DE (US)

(72) Inventors: Achref Methenni, Montreal (CA); Michael Starsinic, Newtown, PA (US); Taimoor Abbas, Sainte-Julie (CA); Saad Ahmad, Montreal (CA); Ulises Olvera-Hernandez, Saint-Lazare (CA)

(21) Appl. No.: 19/055,871

(22) Filed: Feb. 18, 2025

(51) Int. Cl. H04W 60/00; H04W 48/18

(52) U.S. Cl. CPC H04W 60/00; H04W 48/18

(57) ABSTRACT

Procedures, methods, architectures, apparatuses, systems, and devices are provided for a node of a wireless network to register a wireless transmit/receive unit (WTRU) for communication with the wireless network. A method includes receiving, from a WTRU, a radio resource control message including a registration message and an access node parameter of the WTRU. The method includes selecting, based on the access node parameter and based on querying the wireless network, an instance of a network function from a plurality of available network function instances, wherein the instance of the network function supports a registration of the WTRU. The method includes receiving, from the wireless network, a response message including a temporary identification associated with the access node parameter of the WTRU. The method includes causing the WTRU to be registered for communication with the wireless network based on the temporary identification and based on the instance of the network function.

### TECHNICAL FIELD

The present disclosure is generally directed to the fields of communications, hardware, software and encoding, including, for example, to methods, architectures, apparatuses, and systems related to device registration at wireless networks, including a device registration that can be initiated by a wireless transmit/receive unit (WTRU) to be registered.

### BACKGROUND

In a 5G system (5GS), when a user equipment (UE) wants to initiate a registration procedure with the 5G network, a WTRU or a UE sends a non-access stratum network (NAS) message (e.g., which may be a registration message) to the 5G core network (5GC) via a radio access network (RAN) node. For example, the UE may send the NAS message to the access and mobility management function (AMF) via the RAN node. The UE may include network access parameters in the registration message. Such parameters may include a public land mobile network (PLMN) identification (ID) and/or a subscription concealed identifier (SUCI), e.g., for supporting an initial registration of the UE. If the UE has previously registered with the network, it may not provide identifiers such as a globally unique AMF identifier (GUAMI) to help identify the appropriate AMF, a 5G shortened temporary mobile subscriber identification (5G-S-TMSI), any temporary identifier, or any combination thereof. Accordingly, the RAN node may use the PLMN ID to identify an appropriate AMF for registration. To identify the appropriate AMF, the RAN may identify and rely on a local configuration, may check for existing active network interface connections (e.g., N2 interface connections), or query a domain name system (DNS) server for AMF instances with addressing information. For example, the addressing information could be an internet protocol (IP) address, a fully qualified domain name (FQDN), any other suitable information, or any combination thereof. The RAN node may determine the initial AMF based on one of these aforementioned approaches.

Having determined an AMF, the RAN routes the NAS message or registration request of the UE to the AMF. Upon receipt of the request, the AMF checks for an existing UE context. For example, the AMF may perform steps of registration procedure as specified in clause 4.2.2.2.2 of the Third Generation Partnership Project (3GPP) technical specification (TS) 23.502. During this selection process, the AMF may perform AUSF selection, e.g., using a UE a SUCI or UE routing indicator. During this selection process, the AMF may also select a unified data management (UDM) and policy control function (PCF) to associate with the registration. For example, selecting the UDM and/or the PCF may include using network repository function (NRF)-based discovery services.

When the registration has been successfully completed, the AMF creates or updates a UE context, and allocates a new temporary ID for the UE. The new temporary ID may be called a 5G-GUTI. The AMF may indicate the successful registration by sending a registration accept message to the UE via the RAN node. The accept message may include the newly allocated 5G-GUTI and other information relevant to the UE. This registration process is dependent upon a specific network architecture.

### SUMMARY

Future wireless networks (e.g., 6^{th} generation, or 6G, networks) may have a different network architecture than 5G networks. For example, compared to a 5G network, a future 6G network may eliminate the AMF and disaggregate the operations of the AMF (as occur in 5G architectures) across other core network functions. In such a 6G network, there would need to be new architectural configurations to select the proper core network functions (and possibly specific instances of those functions) for reproducing the operations of a 5G AMF. In accordance with certain embodiments of the subject matter of this disclosure, a RAN node is configured to select one or more core network functions (and one or more instances thereof) in response to receiving a registration (or update) request from a UE. By selecting the proper core network functions, the RAN node may cause the UE to be registered for communication with the wireless network without having to interact with an AMF.

In certain representative embodiments, a method is performed by a node of a wireless network. For example, the method may be performed to register a WTRU (e.g., where the registration may be an initial registration) based on a registration process that is initiated by the WTRU (e.g., via sending a message). The method includes receiving, from a wireless transmit/receive unit (WTRU), a radio resource control (RRC) message including a registration message and an access node parameter of the WTRU. The method includes selecting, based on the access node parameter and based on querying the wireless network, an instance of a network function from a plurality of available network function instances, wherein the instance of the network function supports a registration of the WTRU. The method includes receiving, from the wireless network, a response message including a temporary identification associated with the access node parameter of the WTRU. The method includes causing the WTRU to be registered for communication with the wireless network based on the temporary identification and based on the instance of the network function.

In certain representative embodiments, a node of a wireless network includes processing circuitry and communication circuitry. For example, the node (e.g., a RAN node) may register a WTRU (e.g., where the registration may be an initial registration) based on a registration process that is initiated by the WTRU (e.g., via sending a message). The node is configured to receive, from a wireless transmit/receive unit (WTRU), a radio resource control (RRC) message including a registration message and an access node parameter of the WTRU. The node is configured to select, based on the access node parameter and based on querying the wireless network, an instance of a network function from a plurality of available network function instances, wherein the instance of the network function supports a registration of the WTRU. The node is configured to receive, from the wireless network, a response message including a temporary identification associated with the access node parameter of the WTRU. The node is configured to cause the WTRU to be registered for communication with the wireless network based on the temporary identification and based on the instance of the network function.

### BRIEF DESCRIPTION OF THE DRAWINGS

A more detailed understanding may be had from the detailed description below, given by way of example in conjunction with drawings appended hereto. Figures in such drawings, like the detailed description, are examples. As such, the Figures (FIGS.) and the detailed description are not to be considered limiting, and other equally effective examples are possible and likely. Furthermore, like reference numerals (“ref.”) in the FIGS. indicate like elements, and wherein:

FIG. 1A is a system diagram illustrating an example communications system;

FIG. 1B is a system diagram illustrating an example wireless transmit and/or receive unit (WTRU) that may be used within the communications system illustrated in FIG. 1A;

FIG. 1C is a system diagram illustrating an example radio access network (RAN) and an example core network (CN) that may be used within the communications system illustrated in FIG. 1A;

FIG. 1D is a system diagram illustrating a further example RAN and a further example CN that may be used within the communications system illustrated in FIG. 1A;

FIG. 2 is an illustrative block diagram of components of a RAN node that may be used as part of, or in connection with, the components depicted in FIGS. 1A-1D;

FIG. 3 is an illustrative system diagram of a wireless network architecture, in accordance with some embodiments of this disclosure;

FIG. 4A is a flow diagram of a first part of an illustrative method for a UE-initiated registration at a wireless network, in accordance with some embodiments of this disclosure;

FIG. 4B is a flow diagram of a second part of the illustrative method for a UE-initiated registration at a wireless network, in accordance with some embodiments of this disclosure;

FIG. 5 is a flow diagram of an illustrative method for a UE-initiated periodic registration update, in accordance with some embodiments of this disclosure;

FIG. 6 is a flow diagram of an illustrative method for a UE-initiated service request, in accordance with some embodiments of this disclosure;

FIG. 7 is a flow diagram of an illustrative method for a UE-initiated policy request, in accordance with some embodiments of this disclosure; and

FIG. 8 is a flow diagram of an illustrative method for registering a UE to communicate with a wireless network using a node of the wireless network, in accordance with some embodiments of this disclosure.

### DETAILED DESCRIPTION

In the following detailed description, numerous specific details are set forth to provide a thorough understanding of embodiments and/or examples disclosed herein. However, it will be understood that such embodiments and examples may be practiced without some or all of the specific details set forth herein. In other instances, well-known methods, procedures, components and circuits have not been described in detail, so as not to obscure the following description. Further, embodiments and examples not specifically described herein may be practiced in lieu of, or in combination with, the embodiments and other examples described, disclosed or otherwise provided explicitly, implicitly and/or inherently (collectively “provided”) herein. Although various embodiments are described and/or claimed herein in which an apparatus, system, device, etc. and/or any element thereof carries out an operation, process, algorithm, function, etc. and/or any portion thereof, it is to be understood that any embodiments described and/or claimed herein assume that any apparatus, system, device, etc. and/or any element thereof is configured to carry out any operation, process, algorithm, function, etc. and/or any portion thereof.

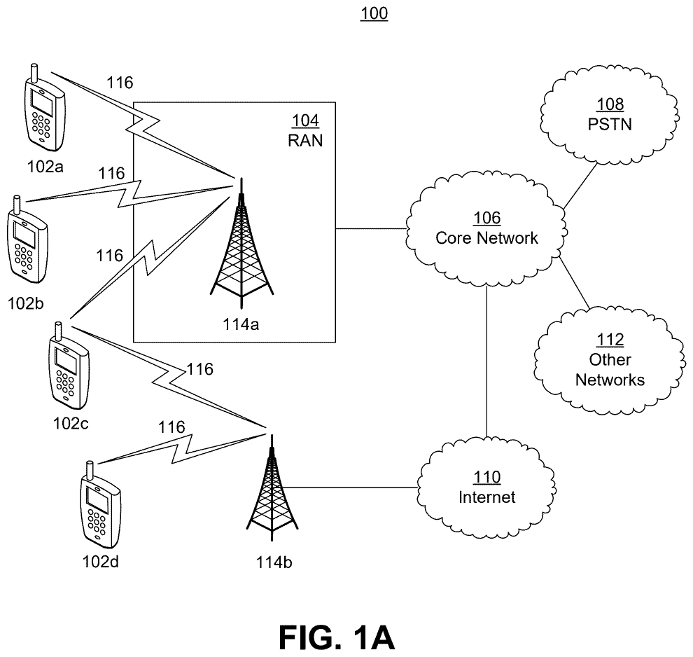

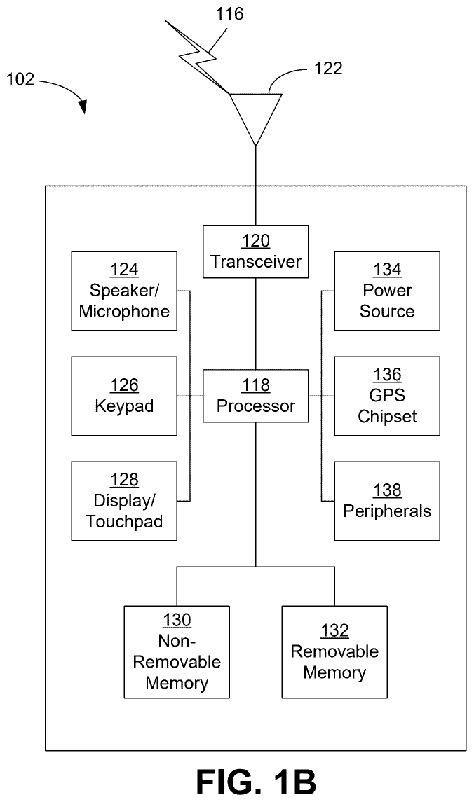

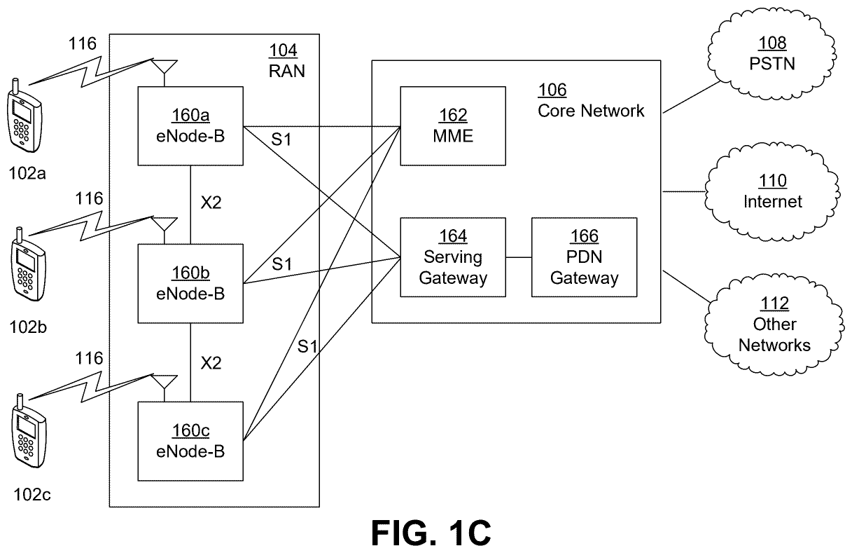

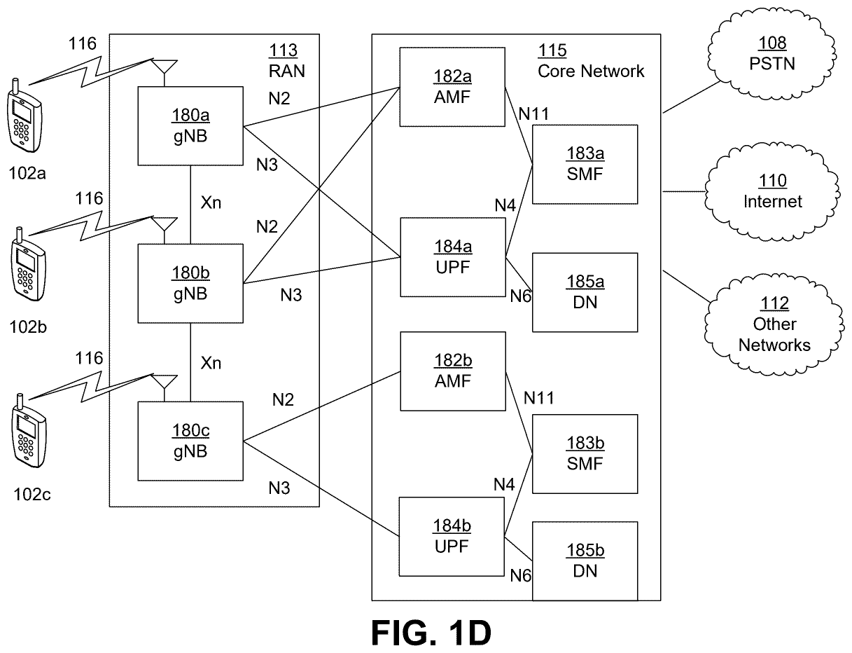

The methods, apparatuses and systems provided herein are well-suited for communications involving both wired and wireless networks (which may be referred to more succinctly as networks). An overview of various types of wireless devices and infrastructure is provided at least in connection with FIGS. 1A-1D, where various elements of the network may utilize, perform, be arranged in accordance with and/or be adapted and/or configured for the methods, apparatuses and systems provided herein.

FIG. 1A is a system diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail (ZT) unique-word (UW) discreet Fourier transform (DFT) spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit and/or receive units (WTRUs) 102a, 102b, 102c, 102d, a radio access network (RAN) 104/113, a core network (CN) 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include (or be) a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE, and vice versa.

The communications systems 100 may also include a base station 114a and/or a base station 114b. Each of the base stations 114a, 114b may be any type of device configured to wirelessly interface with at least one of the WTRUs 102a, 102b, 102c, 102d, e.g., to facilitate access to one or more communication networks, such as the CN 106/115, the Internet 110, and/or the networks 112. By way of example, the base stations 114a, 114b may be any of a base transceiver station (BTS), a Node-B (NB), an eNode-B (eNB), a Home Node-B (HNB), a Home eNode-B (HeNB), a gNode-B (gNB), a NR Node-B (NR NB), a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in an embodiment, the base station 114a may include three transceivers, i.e., one for each sector of the cell. In an embodiment, the base station 114a may employ multiple-input multiple output (MIMO) technology and may utilize multiple transceivers for each or any sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 116 using wideband CDMA (WCDMA). WCDMA may include communication protocols such as High-Speed Packet Access (HSPA) and/or Evolved HSPA (HSPA+). HSPA may include High-Speed Downlink Packet Access (HSDPA) and/or High-Speed Uplink Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In an embodiment, the base station 114a and the WTRUs 102a, 102b, 102c may implement radio technologies such as IEEE 802.11 (i.e., Wireless Fidelity (Wi-Fi), IEEE 802.16 (i.e., Worldwide Interoperability for Microwave Access (WiMAX)), CDMA2000, CDMA2000 1X, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node-B, Home eNode-B, or access point, for example, and may utilize any suitable radio access technology (RAT) for facilitating wireless connectivity in a localized area, such as a place of business, a home, a vehicle, a campus, an industrial facility, an air corridor (e.g., for use by drones), a roadway, and the like. In an embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In an embodiment, the base station 114b and the WTRUs 102c, 102d may utilize a cellular-based RAT (e.g., WCDMA, CDMA2000, GSM, LTE, LTE-A, LTE-A Pro, NR, etc.) to establish any of a small cell, picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing an NR radio technology, the CN 106/115 may also be in communication with another RAN (not shown) employing any of a GSM, UMTS, CDMA 2000, WiMAX, E-UTRA, or Wi-Fi radio technology.

The CN 106/115 may also serve as a gateway for the WTRUs 102a, 102b, 102c, 102d to access the PSTN 108, the Internet 110, and/or other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/114 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other elements/peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together, e.g., in an electronic package or chip.

The transmit/receive element 122 may be configured to transmit signals to, or receive signals from, a base station (e.g., the base station 114a) over the air interface 116. For example, in an embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In an embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. For example, the WTRU 102 may employ MIMO technology. Thus, in an embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other elements/peripherals 138, which may include one or more software and/or hardware modules/units that provide additional features, functionality and/or wired or wireless connectivity. For example, the elements/peripherals 138 may include an accelerometer, an e-compass, a satellite transceiver, a digital camera (e.g., for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a virtual reality and/or augmented reality (VR/AR) device, an activity tracker, and the like. The elements/peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the uplink (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WTRU 102 may include a half-duplex radio for which transmission and reception of some or all of the signals (e.g., associated with particular subframes for either the uplink (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, and 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In an embodiment, the eNode-Bs 160a, 160b, 160c may implement MIMO technology. Thus, the eNode-B 160a, for example, may use multiple antennas to transmit wireless signals to, and receive wireless signals from, the WTRU 102a.

Each of the eNode-Bs 160a, 160b, and 160c may be associated with a particular cell (not shown) and may be configured to handle radio resource management decisions, handover decisions, scheduling of users in the uplink (UL) and/or downlink (DL), and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (PGW) 166. While each of the foregoing elements are depicted as part of the CN 106, it will be appreciated that any one of these elements may be owned and/or operated by an entity other than the CN operator.

The MME 162 may be connected to each of the eNode-Bs 160a, 160b, and 160c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode-Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode-B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in infrastructure basic service set (BSS) mode may have an access point (AP) for the BSS and one or more stations (STAs) associated with the AP. The AP may have an access or an interface to a distribution system (DS) or another type of wired/wireless network that carries traffic into and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier sense multiple access with collision avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High throughput (HT) STAs may use a 40 MHz wide channel for communication, for example, via a combination of the primary 20 MHz channel with an adjacent or nonadjacent 20 MHz channel to form a 40 MHz wide channel.

Very high throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse fast Fourier transform (IFFT) processing, and time domain processing, may be done on each stream separately. The streams may be mapped on to the two 80 MHz channels, and the data may be transmitted by a transmitting STA. At the receiver of the receiving STA, the above-described operation for the 80+80 configuration may be reversed, and the combined data may be sent to a medium access control (MAC) layer, entity, etc.

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV white space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support meter type control/machine-type communications (MTC), such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or network allocation vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In an embodiment, the gNBs 180a, 180b, 180c may implement MIMO technology. For example, gNBs 180a, 180b may utilize beamforming to transmit signals to and/or receive signals from the WTRUs 102a, 102b, 102c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including a varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards user plane functions (UPFs) 184a, 184b, routing of control plane information towards access and mobility management functions (AMFs) 182a, 182b, and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and at least one Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different protocol data unit (PDU) sessions with different requirements), selecting a particular SMF 183a, 183b, management of the registration area, termination of non-access stratum (NAS) signaling, mobility management, and the like. Network slicing may be used by the AMF 182a, 182b, e.g., to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for MTC access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as Wi-Fi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, e.g., to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In an embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

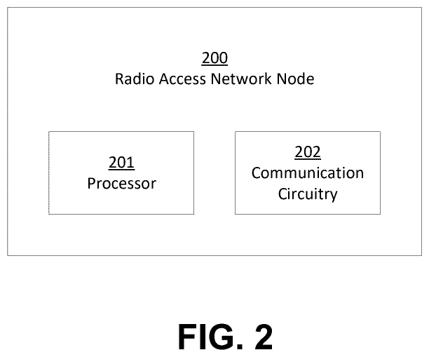

In view of the descriptions provided in connection with FIGS. 1A-1D, and further in view of the following descriptions provided in connection with FIGS. 2-8, it will be understood that a wireless network may include any suitable components and devices, including, for example, any of one or more base stations, one or more TRPs, one or more gNBs, one or more WTRUs, any other suitable device or component, or any combination thereof. It will be further understood that a component or device that is part of the wireless network can be referred to as communicating with the wireless network when it is communicating with any one or more other components or devices of the wireless network. For example, reference to a WTRU, which is part of the wireless network, transmitting or receiving signals to or from the wireless network refers to the WTRU transmitting or receiving signals, respectively, to or from any other component or device (e.g., another WTRU) of the wireless network.

In view of the descriptions provided in connection with FIGS. 1A-1D, and further in view of the following descriptions provided in connection with FIGS. 2-8, a node (e.g., of a wireless network) may generally refer to any physical component that communicates with any other physical component of a wireless network. For example, any physical component performing functions of the RAN may be a node, a gNB may be a node, an eNB may be a node, a WTRU may be a node, a base station may be a node, a DNS server may be a node, and any other equipment configured to communicate with and/or provide a function of the wireless network may be a node. In some instances, multiple aspects of the wireless network (e.g., a DNS server and equipment providing at least one function of the network, equipment providing multiple functions of the wireless network, or equipment providing multiple instances of a single function of the wireless network) may be collocated at a single node.

In view of the descriptions provided in connection with FIGS. 1A-1D, and further in view of the following descriptions provided in connection with FIGS. 2-8, methods, architectures, apparatuses and systems are provided for UE-initiated registration at a wireless network. In certain representative embodiments, the UE (which, again, may be used interchangeably with WTRU in this disclosure) registers at the wireless network based on communication with and operations performed by a RAN node (e.g., any suitable component of RAN 104/113, such as base station 114a or any gNB 180a-180c). In other representative embodiments, the subject matter of this disclosure may be performed by any other suitable node of a wireless network that routes communication between a UE and a core network 106/115. Routing communication may include selecting a particular instance of a network function. As used herein, an “instance” of a network function may be used interchangeably with a network function “ID”.

FIG. 2 is an illustrative block diagram of components of a RAN node that may be used as part of, or in connection with, the components depicted in FIGS. 1A-1D. RAN node 200 includes at least processor 201 and communication circuitry 202. Processor 201 may be configured to process the contents of incoming messages (e.g., as received from a WTRU or from any component of a core network) and generate outgoing messages (e.g., as may be sent to a WTRU or any component of a core network). Communication circuitry 202 may be configured to receive any incoming messages and transmit any outgoing messages. RAN node 200 may also include, or be coupled to, memory and any other physical components as may be needed to support the operations of processor 201 and communication circuitry 202.

How RAN node 200 operates may depend on the infrastructure of a core network (e.g., core network 106/115) to which RAN node 200 is communicatively coupled. In potential next generation (i.e., 6G) core network architectures, RAN node 200 may be configured for operational differences as compared to how RAN node 200 integrates with current generation (i.e., 5G) core network architectures. Some illustrative examples of possible next generation system architectures, and some illustrative examples of how these new architectures may relate to the operation of RAN node 200, are described as follows.

A 6G RAN node (e.g., RAN node 200), which may be referred to as a 6G Access Node (6G-AN) throughout this disclosure, may be configured to support a next generation Core Network (nCn) that operates using a service-based interface (SBI). Through the SBI, the 6G-AN may directly invoke the services needed according to the procedure being performed with the UE. In certain representative embodiments, the implementation of the SBI obviates the need for an AMF; rather, the 6G-AN may coordinate directly with the nCn to provide the same services as the AMF based on directly invoking other network functions that may have previously been invoked by the AMF or performed by the AMF.

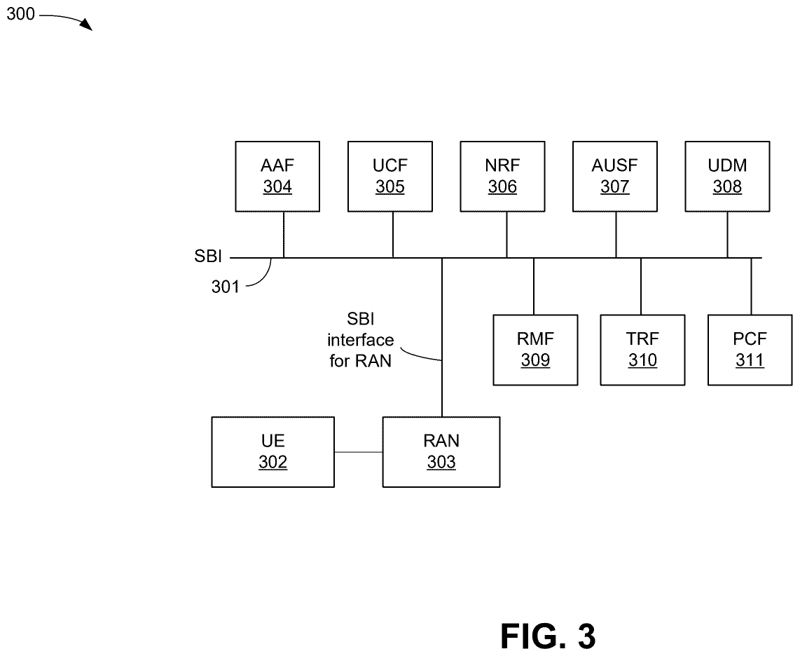

FIG. 3 is an illustrative system diagram of wireless network architecture 300, in accordance with some embodiments of this disclosure. For example, system diagram 300 may depict an nCn configured to operate based in part on the use of SBI 301. As shown, UE 302 connects to wireless network architecture 300 via RAN 303 (e.g., via a RAN node, such as RAN node 200, of RAN 303). RAN 303 connects UE 302 to other functions of wireless network architecture 300 over SBI 301, the other functions including, but not limited to, authentication and authorization function (AAF) 304, unified context management function (UCF) 305, network repository function (NRF) 306, authentication server function (AUSF) 307, unified data management (UDM) 308, registration and mobility management function (RMF) 309, tracking and reachability function (TRF) 310, and policy control function (PCF) 311. In certain representative embodiments, RAN 303 as shown in FIG. 3 may represent a 6G-AN.

In certain representative embodiments, the RAN 303 first invokes AAF 304 when a UE 302 requests initial access to the wireless network. The AAF 304 acts as a generic authenticator (e.g., in an extensible authentication protocol (EAP) framework) that may provide different types of authentications (e.g., primary or secondary authentication) towards different authentication servers. For example, the different authentication servers may include AUSF 307, or a third party authentication authorization accounting (AAA). The AAF may be invoked and reused in different procedures by different NFs for example in a primary authentication (e.g., by RAN 303), in a PDU Session secondary authentication (e.g., by an SMF), in a slice or user identity specific authentication (e.g., by an RMF) etc.

Once UE 302 is successfully identified and authenticated, RAN 303 can invoke the service of UCF 30, which maintains state information related to UE 302. The state information may include a registration/connection states, location, security context, subscription data from UDM, any other suitable information, or any combination thereof.

RAN 303 invokes the service of RMF 309 for access control or mobility updates of UE 302. RMF 309 may rely on another network function (NF), such as UCF 305, for state information maintenance.

RAN 303 may invoke the service of TRF 310 to allows UE 302 to provision tracking information. The tracking information may enable new UE tracking capabilities within the network and adaptive tracking strategies.

As mentioned, in 6GS, the access and mobility management functionality (e.g., as performed by an AMF in 5GS), may be disaggregated into more than one NF. For example, the functionality may be distributed across at least two of AAF 304, UCF 305, RMF 309, TRF 310, or any of the other functions shown in FIG. 3. Each of those functions may handle different aspects of the AMF capabilities. For example, one NF may provide registration management functionality, a second NF may provide Authentication and Authorization functionality, a third NF may provide context management functionality, a fourth NF may provide tracking and reachability (i.e. mobility management) functionality.

Further, in 6GS, network interfaces (e.g., N2 or N3 interfaces) may no longer be needed based on the introduction of an SBI (e.g., SBI 301) that may be made available to nodes of RAN (e.g., nodes of RAN 303, including but not limited to 6G-ANs), enabling such RAN nodes to able to communicate with other NFs over the SBI interfaces.

In the context of a UE interacting with a wireless network for registration purposes (e.g., for a UE-initiated registration), a 6G-AN may need to interact with at least one of the above-mentioned network functions to register the UE. In the absence of certain representative embodiments of the subject matter of this disclosure, the RAN node may not be configured to determine which network functions, or which instances of network functions, to interact with to support the UE registration request. In other words, certain representative embodiments of the subject matter of this disclosure may provide a RAN node configured to determine which network functions to route UE registration messages to, e.g., for initial registration requests and for subsequent update requests (e.g., registration updates, service updates, or policy updates).

When transmitting an initial registration request, a UE may not have a proper identification (e.g., a temporary identification) as may be needed to complete the registration. Without such an identification, and without relying on RAN node operations provided herein, a RAN network may not be able to determine which network functions should be invoked to support the registration (e.g., where the network functions, such as RMF, TRF, UCF, AAF, may provide aspects of access and mobility network functions). As disclosed herein, a RAN node may be configured to determine the identity of network functions (e.g., the specific function from among multiple available functions, as well as a specific instance of that specific function) so that the RAN can properly route the UE registration messages to the appropriate NF(s).

In certain representative embodiments, the initial UE registration request may be followed by subsequent requests initiated by the UE (e.g., registration update, service update, and/or policy update requests). For example, the UE may want to update the specific network functions with which it can interact, or update the network services available to the UE (e.g., such that the UE can update or negotiate a policy with a PCF function). To enable such operations and realize a 6G system, enhancements to the current 5G system may be needed. Based on these enhancements, a RAN node may receive provide sufficient identification and service—related information from the UE, causing the UE message or request to be processed, validated, and routed to the appropriate network function (e.g., of the nCn).

In certain representative embodiments of this disclosure, UE and network interactions (e.g., via a RAN node) are provided for two use cases.

In the first use case, the UE is performing an initial registration procedure with the network, and UE does not have a temporary ID (e.g., 6G-GUTI), to use. This disclosure describes how the RAN node can determine and select the network functions related to UE registration procedure in order to register the UE (e.g., without use of an AMF). This disclosure describes the allocation of a UE temporary ID by the 6G network functions. This disclosure provides information (e.g., beyond that which is currently provided in 5G registration protocols) that can be provided to the UE by the network after a successful initial registration procedure to help the UE interact with the network thereafter. Further provided herein are examples of illustrative approaches for constructing the temporary ID to assist with the routing of messages from RAN to the respective NFs.

In the second use case, the UE has successfully performed an initial registration procedure, including obtaining a temporary ID and other information that helps the UE interact with the network. This disclosure describes subsequent scenarios in which the UE interacts with the network by providing an update request and, e.g., relying on different parameters available to the RAN node toward causing the UE to update according to the update request. This disclosure provides RAN node configurations for using the new information (e.g., including the details of the update request) to validate and route the UE message to the network functions that are needed to evaluate the update request and to cause the UE to update based on the request.

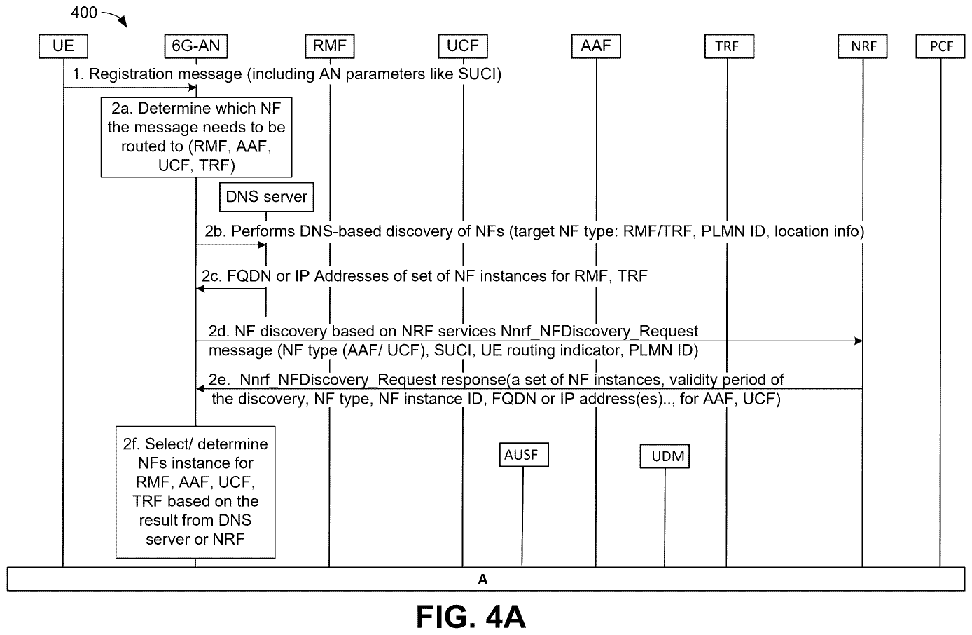

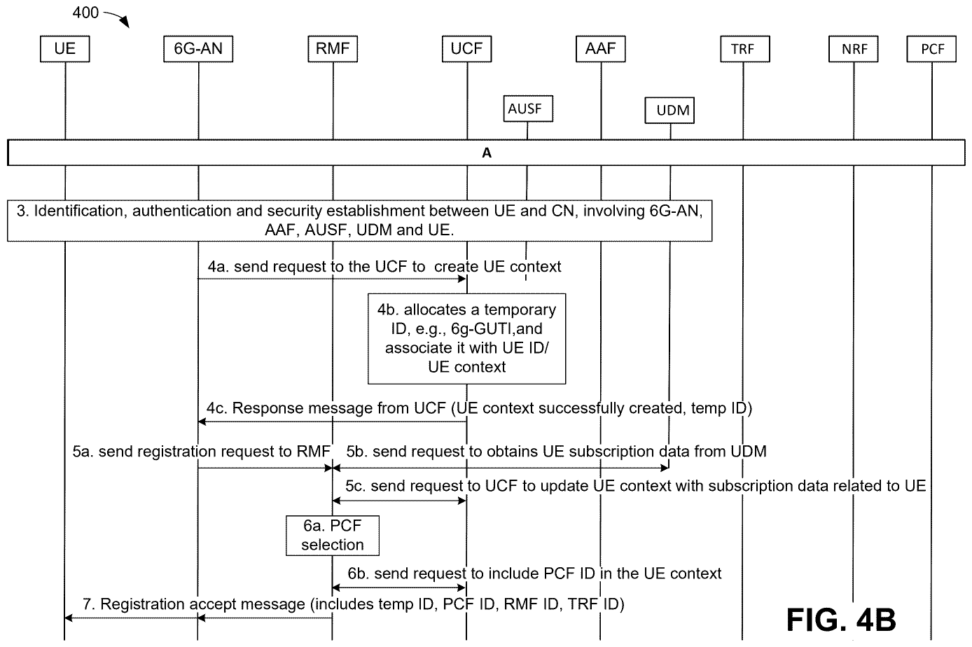

FIG. 4A is a flow diagram of a first part of an illustrative method for a UE-initiated registration at a wireless network, and FIG. 4B is a flow diagram of a second part of the illustrative method for a UE-initiated registration at a wireless network in accordance with some embodiments of this disclosure. Together, FIGS. 4A and 4B show illustrative method 400, which may correspond to an example of a procedure for initially registering a UE for communication with other components of a 6G network.

In FIGS. 4A, 4B, and 5-7: the UE, as shown, may be any of the WTRUs shown in connection with FIGS. 1A-1D, or UE 302; the 6G-AN, as shown, may be a base station 114, any gNB or eNB shown in FIGS. 1C-1D, any other node of RAN 104/113, RAN node 200, or a node of RAN 303; and any function, as shown, may be the same as the corresponding function of FIG. 3, and may be coupled to other functions and to the RAN node over SBI 301.

Method 400 and the corresponding discussion describe how the RAN is configured to determine the network functions that serve the initial UE registration. Examples of information that is provided during the registration, as well as information that is provided to indicate a successful registration, are provided to support certain representative embodiments of method 400.

As noted, in a 6G system architecture, the AMF (e.g., as is used in 5G systems) may be disaggregated, and multiple network functions (e.g., the RMF, UCF, AUSF, AAF, UDM, TRF, NRF, PCF, any other function, or any combination thereof) may perform different subsets of the collective tasks that may be performed by the AMF in 5G systems.

In connection with method 400, during the initial registration, the RAN node needs to be able to determine which NFs, such as RMF, TRF, UCF, AAF as shown in FIGS. 4A and 4B, are the NFs that support initial registration of the UE.

In FIG. 4A, two possible approaches are shown for determining which candidate NFs are needed to support the initial UE registration. Based on steps 2b and 2c, as shown, the RAN node can perform a DNS-based discovery to obtain the candidate NFs. Based on steps 2d and 2e, as shown, the RAN node can perform an NRF-based discovery to obtain the candidate NFs. In certain representative embodiments, the RAN node may execute one of: steps 2b and 2c; or steps 2d and 2e. In other representative embodiments, the RAN node may execute both of those possible approaches (e.g., for redundancy, speed, access to respective functions, any other suitable reason, or any combination thereof).

As per performing an initial registration, at the start of method 400, the UE does not have a valid temporary ID, e.g., 6g-GUTI or any other similar identifier, to provide to the network. Thus, the RAN node may be configured use information that is sent by the UE such as PLMN ID, SUCI, or location information and queries a DNS server about candidates NFs that support the UE for Access and Mobility Management (AM). For example, the RAN node may receive a radio resource control (RRC) message that is sent by the UE. The RRC message may be a NAS Registration message and may include one or more access network (AN) parameters, such as a first PLMN ID, a SUCI, a UE identifier, or any combination thereof. The first PLMN ID may identify the network that the UE wants to register to (i.e. the network that the UE wants to send the NAS Registration message to). It may be necessary for the UE to identify the network that the UE wants to register to because, in network sharing scenarios, the RAN node receiving the message may be associated with more than one PLMN. The RAN node may select the network function from multiple available network functions (e.g., selecting at least one of the functions shown in FIG. 3, where every function shown in FIG. 3 can be an available network function) based at least in part on the access node parameter.

The UE identifier may identify the home PLMN of the UE (i.e., the HPLMN ID). The RAN node may use the HPLMN ID of the UE, the PLMN ID of the network that the UE wants to register to, and a network function type to query the wireless network (e.g., the DNS server or the NRF, as shown in FIG. 4A) to receive a fully qualified domain name (FQDN), or otherwise to receive an IP address. The RAN node may receive the FQDN based on querying the DNS (e.g., as shown in step 2b of FIG. 4A) to obtain an NF identity. The specific type of network function that is used to construct the FQDN may be the same type of network function to which the RAN needs to forward the UE registration message. The RAN node may determine/select the type of network function (e.g., from multiple available network functions that support a registration of the UE) that the message needs to be forwarded to based on the type of NAS message that is carried in the RRC message. For example, the RRC message may include a field that indicates what type of NAS message is carried in the RRC message. Instead of, or in addition to, querying the DNS, the RAN node may query an NRF, as mentioned above. For example, the RAN node may communicate with the NRF through respective connections to an SBI interface, and may use the NRF to discover NFs using NRF-based NF discovery services. Whether the RAN node queries the DNS server, the NRF, or both, the UE may provide an identifier like a SUCI to help with UE identification during the querying and/or during the corresponding registration.

The RAN may use the access node parameters (e.g., including, but not limited to a SUCI and a UE routing indicator that indicates a NF to which the message should be routed) to discover NFs that can support the UE for AM operations. In other words, the RAN Node may send a query message to the DNS server, to the NRF, or to both. The query message may include the HPLMN ID of the UE, the PLMN ID of the network that the UE wants to register to, and a network function type (e.g., where including the network function type may correspond to including the routing indicator provided by the UE). The query response, as received by the RAN node, may include an instance of the network function (e.g., an NF ID). Alternatively, the RAN node may use the PLMN ID of the network to which the UE wants to register to determine that an NRF should be queried. The RAN node may then send a query message to the NRF (e.g., to any suitable instance of the NRF, which may be determined by the RAN node or indicated by the UE), the query message including the HPLMN ID of the UE and/or a network function type. The query response from the NRF may include an NF ID.

In certain representative embodiments, the RAN node may be configured to explicitly request that the UE send a SUCI, e.g., if the SUCI is not provided in the registration message received at step 1 of FIG. 4A.

As per the descriptions provided in connection with steps 2b, 2c, 2d, and 2e of FIG. 4A, method 400 may include the RAN performing DNS based discovery for TRF and RMF network functions, and NRF based discovery for AAF and UCF functions. However, these configurations are merely illustrative; indeed, the RAN node may perform DNS-based or NRF-based NF discovery irrespective of the specific functions to be discovered. That is, any one or more network functions needed to support UE registration may be discovered based on querying either one of the DNS server or the NRF.

In connection with method 400, it may be assumed that the RAN node discovers and selects the AAF similarly to how AUSF discovery occurs in 5GS, the UCF similarly to how UDM discovery and selection occurs in 5GS, and the RMF and TRF selection similarly to the AMF is selected for the 5GS UE initial registration procedure. As mentioned, the RAN node can use any suitable approach provided in this disclosure to discover and determine the NFs for the initial UE registration procedure.

As follows, the enumerated steps of method 400 are described in detail. These descriptions are provided to further explain or expand upon the above descriptions of aspects of method 400. These descriptions shall not be limiting of any other illustrative wireless network configurations provided in this disclosure. The horizontal boxes annotated with an “A” are included to depict how the second part of method 400, as shown in FIG. 4B, follows from the first part of method 400, as shown in FIG. 4A.

In step 1, as shown in FIG. 4A, the UE sends a registration message to the 6G-AN to communicate with a 6GS. This message is an initial registration message. The registration message includes AN-related parameters. The AN parameters may include the PLMN ID or SUCI. As used in this disclosure, a SUCI may be an identity of a UE that includes multiple parts, one or more of which can be used to identity the HPLMN of the UE. The AN parameters may also identity the PLMN to which the UE wants to register. The 6G-AN can read the AN parameters, e.g., during an RRC connection setup procedure. The AN parameters may also include an RRC establishment cause. The AN parameters may also include a message type field or service type field, e.g., that indicates what type of message the UE is sending, or what type of service the UE is attempting to obtain from the 6GS. For example, the message type can have a value of “initial registration”. The registration message also includes a container carrying a registration request message. This container is configured to be forwarded to the NF(s) of interest, e.g., RMF, UCF, TRF, AAF, or any other NF (e.g., as shown at least in FIG. 3 or FIG. 4A). For example, the registration request included in the container may provide a NAS message to be sent to an RMF. That NAS message may indicate a registration type (e.g., an initial registration) and may optionally include other information.

In step 2a, as shown in FIG. 4A, the 6G-AN determines, based on the AN parameter, that it is necessary to determine/select NFs related to access and mobility management. The 6G-AN determines that it is needed to select particular instances of the RMF, AAF, UCF, and/or TRF, to which to route the UE registration message. Because the UE did not include (and, in some cases, at the time of an initial registration request, does not even possess) a temporary ID, such as a globally unique temporary identifier (GUTI) or globally unique AMF identifier (GUAMI), the 6G-AN may use the PLMN ID and SUCI to determine the instances (e.g., based on IP addresses or other wireless network addresses) of some of the NFs mentioned above. It is possible that the 6G-AN determines (e.g., based on any one or more of the AN parameters) to select an RMF, TRF, or other NF using the PLMN ID, with or without assistance from NEF/NRF.

In step 2b, as shown in FIG. 4A, the 6G-AN may use DNS-based discovery to discover RMFs and TRFs. The 6G-AN sends a DNS query to a DNS server to discover RMF and TRF. The 6G-AN may include an FQDN in the query. The 6G-AN may be configured to construct a FQDN query based on the PLMN ID and/or SUCI. The FQDN query may be constructed in a way that indicates that network functions of type RMF and TRF are requested. The 6G-AN may provide location information (e.g., corresponding to a physical location of the UE, or to a network to which the UE wants to connect) in the query to the DNS server. The parameters for the DNS query may depend on the type of message the UE sent to the RAN. In certain representative embodiments, the DNS server may be a server owned by the mobile network operator (MNO) that is associated with the PLMN ID. Thus, the PLMN ID that is included in the RRC message and that indicates what network that the UE wants to register to may be used to determine what DNS to query (e.g., what DNS to send the FQDN resolution request to).

In step 2 c, as shown in FIG. 4A, the DNS server responds to the 6G-AN with IP addresses of candidate instances of RMFs and TRFs. The DNS server may provide FQDN or IP addresses of set of NF instances for RMF and TRF.

In step 2d, as shown in FIG. 4A, the 6G-AN sends a discovery request message to the NRF, e.g., by using a standard protocol (e.g., the Nnrf_NFDiscovery_Request message). The 6G-AN may indicate the NF type as being AAF or UCF. The 6G-AN may also include the UE SUCI and PLMN ID of the network to which the UE wants to register (e.g., if the UE made such an indication in AN parameters of the message of step 1). The discovery request message may also include a UE routing indicator and a PLMN ID.

In step 2e, as shown in FIG. 4A, the NRF processes the discovery request and sends to the 6G-AN at least one NF instance for AAF, at least one NF instance for UCF, or at least one respective NF instance for both of those functions. The response message includes FQDN or IP addresses of AAF and/or UCF instances. The discovery response message may also include a validity period of the discovery result, e.g., indicating a duration for which the referenced instance is known to be valid.

As mentioned, in steps 2b-2c, the 6G-AN uses DNS-based discovery to discover network functions RMF and/or TRF; in steps 2d-2d, the 6G-AN uses NRF-based discovery to discover network functions AAF and/or UCF. In certain representative embodiments, any network function may be executed across multiple instances (e.g., each instance corresponding to a mobile operator, geographic region, service level, policy type, subset of nodes, or any other suitable aspect of the wireless network). Each of those multiple instances may be associated with a respective network function ID, e.g., which may be indicated by an FQDN or IP address.

In step 2f, as shown in FIG. 4A, the 6G-AN uses the discovery results for the RMF and TRF, received from the DNS server (in step 2b, 2c) and/or for the AAF and UCF, as received from the NRF (in step 2d, 2e), to select one or more NF instances to support the UE registration.

In step 3, as shown in FIG. 4B, the 6G-AN and at least one NF (e.g., at least one of AAF, AUSF, UDM), perform security related procedures, including identification, authentication and security establishment, and key agreement between the UE and the core network. Performing these operations of step 3 may be based on communication between the at least one NF and the UE via the 6G-AN.

In step 4a, as shown in FIG. 4B, upon successful completion of the security operations of step 3, the 6G-AN sends a request to the UCF to request to create a UE context for the UE.

In step 4b, as shown in FIG. 4B, the UCF creates a UE context, which may include security related information or other device-specific information. The UCF also allocates a temporary ID for the UE and associates this temporary ID with the UE context and/or with the UE identifier (e.g., SUCI, or subscription permanent identifier (SUPI)). The temporary ID, which can be called 6g-GUTI, may be used by the 6G-AN to determine network functions, such as RMF ID, TRF ID, UCF ID, AAF ID, PCF ID, that are associated with the UE temporary ID.

Additional details of the temporary ID are provided as follows. The temporary ID may be used (e.g., by the 6G-AN or any other suitable RAN node) to determine which NFs, among multiple available NFs (e.g., all of the NFs shown in FIG. 3, FIG. 4A, FIG. 4B, or any combination thereof), should be associated with the UE. For example, the temporary ID may be used to determine the RMF ID and TRF ID that are associated with UE temporary ID.

The temporary ID may be a concatenation of two or more values (e.g., fields, strings, flags, or any combination thereof). The first value may be an identifier that helps determine the serving NFs, such as RMF and TRF. This first value may be called a globally unique disaggregated access and management identifier (GUDAMI). This first value may also (or otherwise) include information about specific NF instances (e.g., as determined by an RMF ID, TRF ID, or any other suitable network function ID) that serve a specific region, and/or that are part of a certain set of RMFs/TRFs. While the first value may directly include a network function ID (e.g., an RMF ID or TRF ID), it may also include information that is derived from the network function ID.

The second value may be a randomly assigned value that identifies the UE within a certain RMF/TRF set. For this example, the 6g-GUTI or temporary ID can be written as:
<6G-GUTI>=<GUDAMI><6G-TMSI>, where:
<GUDAMI>=<MCC><MNC><RMF Identifier><TRF S-Identifier>, and:
<RMF Identifier>=<RMF Region ID><RMF Set ID><RMF Pointer>, and:
<TRF S-Identifier>=<TRF Set ID><TRF Pointer>.

These illustrative second value expressions show how the temporary ID can be a concatenation of different values, each of which may include multiple ID's or other suitable pieces of information. Based on the structure of the temporary ID, a 6G-AN (or any suitable network function coupled to the 6G-AN) can determine the NF IDs of the NFs that are associated with the UE temporary ID; moreover, the other fields that may be randomly assigned to UE can, e.g., be used to differentiate the UE from other devices in the wireless network.

The GUDAMI may also be structured to indicate how many NF identifies have been concatenated. For example, the GUDAMI can be written as:
<GUDAMI>=<MCC><MNC><# of NFs><RMF Identifier><TRF S-Identifier>.

The GUDAMI may also be structured to indicate or to indicate the length of the GUDAMI. For example, the GUDAMI can be written as:
<GUDAMI>=<Length Indicator><MCC><MNC><RMF Identifier><TRF S-Identifier>.

In step 4c, as shown in FIG. 4B, the UCF sends a response to the 6G-AN to indicate that the UE context was successfully created. Receiving this response message at the 6G-AN may include receiving the temporary ID.

In step 5a, as shown in FIG. 4B, the 6G-AN forwards the registration request message to the RMF to continue the registration procedure based on the successful identification, authentication and security establishment performed in step 3 of method 400. In the forwarded message, the 6G-AN includes the UE ID, temporary ID, and UCF ID.

In step 5b, as shown in FIG. 4B, because of receiving the forwarded message from the 6G-AN, the RMF sends a request to the UDM to obtain UE subscription data from UDM (e.g., based on the temporary ID and/or the UE context). The RMF then receives a response from the UDM and processes the received UE subscription data.

In step 5c, as shown in FIG. 4B, the RMF sends a request to the UCF to update UE context to include information such as UE subscription data. Based on the request, the RMF may cause the UCF to include the RMF ID as part of the UE context.

In step 6a, as shown in FIG. 4B, the RMF selects a PCF (e.g., an instance of a PCF) to support the implementation of the proper AM policies for the UE.

In step 6b, as shown in FIG. 4B, the RMF may update the UE context in the UCF to include the PCF ID after the PCF is selected.

In step 7, as shown in FIG. 4B, the 6G-AN receives a registration accept message from the RMF and send the registration accept message to the UE. In other words, the 6G-AN receives a NAS message from the RMF. Then, the 6G-AN sends an RRC message to the UE. The RRC message includes the NAS message from the RMF. The RMF includes the temporary ID of the UE in the NAS message. The RMF also may include, in the NAS message, at least one identifier for at least one NF that is associated with the UE context. Each of those at least one identifier (e.g., to identify an instance of an NF) may be a PCF ID, RMF ID, TRF ID, or any other NF ID. The 6G-AN may include the RMF ID in the RRC message so that the UE can include the RMF ID in subsequent RRC messages (e.g., which may contain NAS messages) that need be routed to the RMF. Based on how the 6G-AN receives and sends messages at step 7, these operations may be referred to as causing the WTRU to be registered for communication with the wireless network based on the temporary identification and based on the instance of the network function.

In certain representative embodiments, the temporary ID generated using method 400, with or without other information provided by the UE or by the core network (e.g., in connection with other aspects of method 400, or following a successful registration), may be used for updating the UE after successful completion of an initial registration. The update may be a subsequent registration (e.g., a periodic registration, which may be a re-registration), a policy update, a service update, or any other update for how the UE communicates with the wireless network.

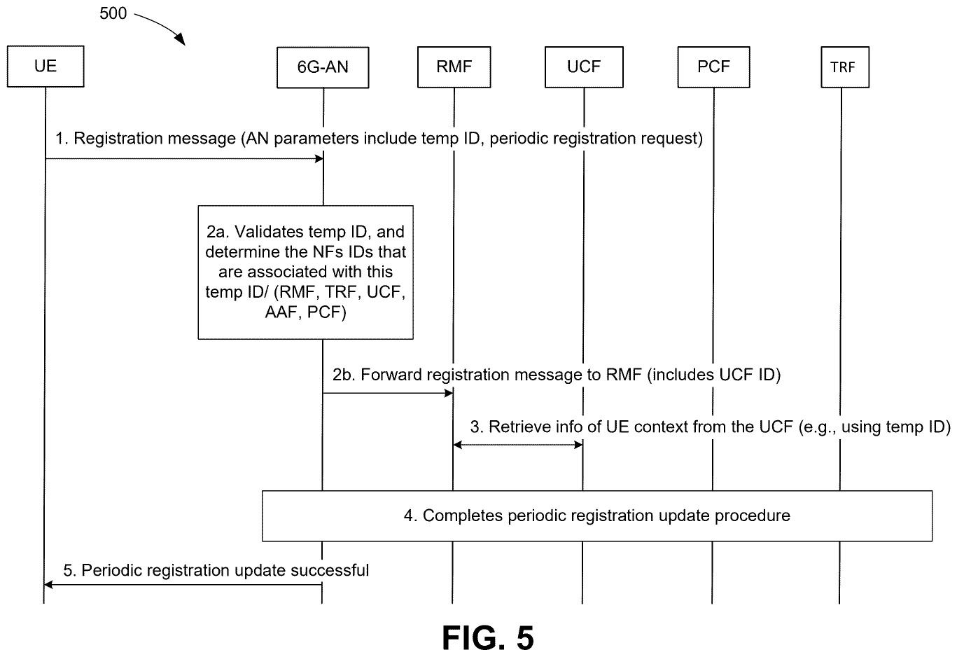

FIGS. 5-7 show three illustrative examples of the UE (e.g., that was initially registered using method 400) interacting with the wireless network, after an initial registration (e.g., for enabling 6GS access). As mentioned, the UE may use the temporary ID obtained during the initial registration to request updates or perform any other suitable procedures. In the three illustrative examples of FIGS. 5-7, the UE may include additional information (e.g., indicating the temporary ID, indicating a particular update, any other information, or any combination thereof) as part of a message (e.g., including an update request) to the 6G-AN. The 6G-AN routes that message to the proper NF of the 6G core network (6GC). In certain representative embodiments, the additional information is available at the RAN node (e.g., stored in memory of the RAN node, and/or made available in the message). In certain representative embodiments, in addition to relying on the obtained temporary ID, the UE may rely on additional information received during the initial registration process to facilitate interactions with the correct NFs to execute the requested update.

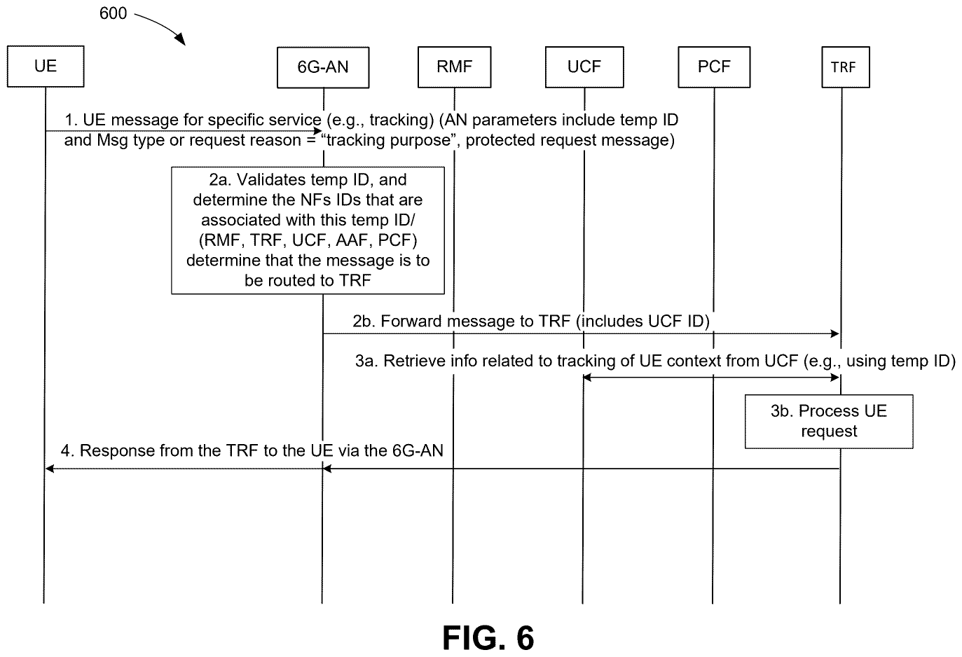

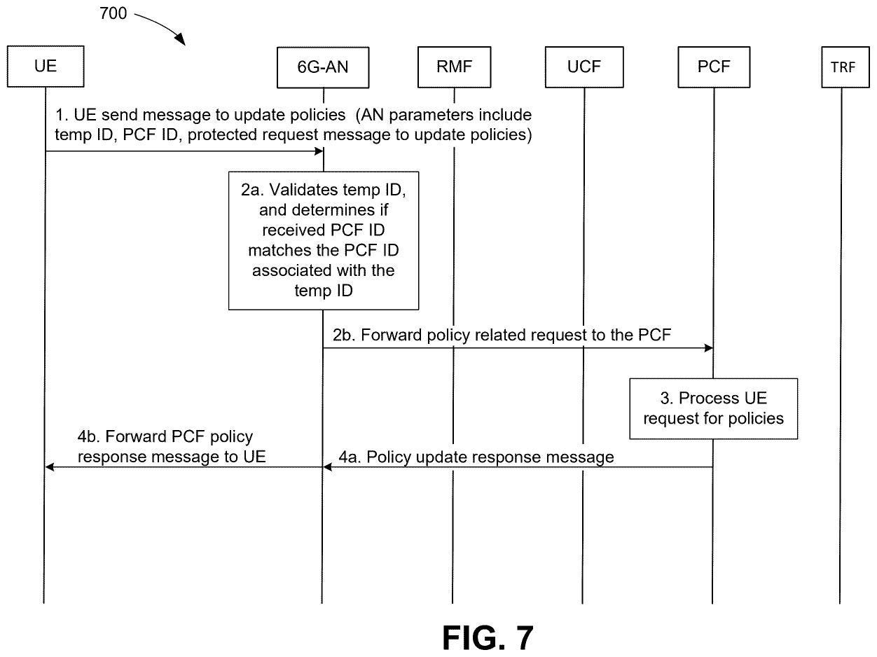

In general, FIGS. 5-7 correspond to a 6G-AN receiving an update request from the UE, where the update request includes the temporary identification, associating the update request with an instance of the network function (e.g., the same instance(s) as was used during the initial registration, and/or a new instance; and the same network function(s) as was used during the initial registration, and/or a new network function) based on the temporary identification, and causing the UE to update its registration based on the update request. In particular, FIG. 5 illustrates a registration update request (e.g., a periodic registration), FIG. 6 illustrates a service update request, and FIG. 7 illustrates a policy update request.

FIG. 5 is a flow diagram of an illustrative method 500 for a UE-initiated periodic registration update, in accordance with some embodiments of this disclosure.

In step 1, as shown in FIG. 5, the UE sends an update request message to the 6G-AN of the 6GS. That update request message indicates that the UE wants to execute a periodic registration update procedure. To do so, the UE includes (e.g., as AN parameters) the temporary ID (e.g., as obtained in an initial registration, which may correspond to method 400) and includes an update request type (e.g., indicating a periodic registration update) that is to be supported by the 6GC.

In step 2a, as shown in FIG. 5, the 6G-AN validates the temporary ID provided by the UE. The 6G-AN uses the validated temporary ID to determine the respective IDs (e.g., the respective instances) of the RMF, TRF, UCF, AAF and PCF that are associated with the temporary ID for the UE.

In step 2b, as shown in FIG. 5, the 6G-AN forwards the UE registration request to identified RMF network function. In this forwarded registration request message, the 6G-AN may also include the UCF ID of the UCF associated with the UE ID. Though not explicitly shown in FIG. 5, the 6G-AN may also interact with the UCF to obtain information related to the UE in the UE context. If such an interaction occurs, the 6G-AN may use information from the UCF, together with information from the AAF, to verify aspects of the UE (e.g., including, but not limited to, authorization and security information).

In step 3, as shown in FIG. 5, the RMF sends a message to the UCF to retrieve information related to the UE context. In that message, the RMF may include the temporary ID of the UE. In a corresponding response from the UCF, the RMF obtains UE context information.

In step 4, as shown in FIG. 5, the 6GS nodes complete the operations for the periodic registration update procedure. These periodic registration update operations may be supported by any suitable number of the NFs as shown in FIG. 5 or as otherwise described in connection with certain embodiments of this disclosure.

In step 5, as shown in FIG. 5, after the periodic registration update is successful, the 6G-AN sends (e.g., forwards) a message to the UE indicating that the periodic registration update has been successfully completed.

FIG. 6 is a flow diagram of an illustrative method 600 for a UE-initiated service request, in accordance with some embodiments of this disclosure. In connection with the service update request, the UE wants to interact with the 6GS. As a result, the UE includes a temporary ID and additional information in a message that is received by the 6G-AN. Based on the temporary ID and the additional information, the 6G-AN routes the UE message service update request message to one or more network functions for supporting that service request update.

In step 1, as shown in FIG. 6, the 6G-AN receives a message from the UE to request a specific service of the 6GS. For example, the UE may want to interact with the network for tracking or location related purposes. In the message, the UE includes AN parameters that thereby are made available to the 6G-AN. For example, the 6G-AN may receive these AN parameters from the UE in an RRC message. Among the AN parameters, the UE includes the temporary ID that is obtained after initial registration procedure (e.g., as may have occurred based on the operations of method 400). The UE may also include, among the AN parameters, a message type or reason for the request, which could indicate the type of message that the UE intends to send to the network, or the reason for why the UE is sending the message to the network. For example, the UE may indicate to the 6G-AN, via a message type value, that the message is for tracking or location related purposes. Alternatively, the UE may use an RRC establishment cause to provide the type of message or the reason for the request. For example, the UE may provide a cause value related to the RRC connection establishment that reflects that the request is related to tracking or location related purposes. As received by the 6G-AN, the UE message may include the request message the UE wants the 6G-AN to send to at least one NF of the network.

In step 2a, as shown in FIG. 6, the 6G-AN validates the temporary ID received from the UE. Based on the validation, the 6G-AN determines the NF IDs associated with the temporary ID. For example, the 6G-AN determines the RMF ID, UCF ID, AAF ID, PCF ID, TRF ID, and/or other NF ID that are associated with the UE temporary ID, or that otherwise support the UE having the validated temporary ID. Additionally, the 6G-AN may use the message type value to determine which one or more network functions to route the message to. For example, if the 6G-AN may determine, based on a message type indicating a tracking purpose, that the message needs to be forwarded to the specific TRF network function ID that supports the UE.

In step 2b, as shown in FIG. 6, the 6G-AN forwards the UE message to the appropriate NF (e.g., the TRF, as shown, and/or any other suitable NF) based on the determination of step 2a, as shown in FIG. 6. The 6G-AN may include, in the forwarded message, the UE temporary ID and the request message sent by the UE. The 6G-AN may additionally provide IDs of relevant NFs (e.g., which are selected from among multiple available TRF IDs), such as UCF ID.

In step 3a, as shown in FIG. 6, the TRF (and/or other supporting NF) interacts with the UCF using the UCF ID. In this interaction, the NF requests to obtain information related to tracking (or whatever other service update is indicated in the request is being made) based on the UE context. The NF may include the UE temporary ID in the corresponding message sent to the UCF.

In step 3b, as shown in FIG. 6, the TRF (and/or other supporting NF) may use the information obtained from the UCF (e.g., indicating or directly providing a UE context) and tracking related information (or other service update related information), together with the UE message, to process the UE service update request. In certain representative embodiments, though not explicitly shown in FIG. 6, the processing of step 3b may include interaction between the TRF (or the other NF processing the request) and other NFs (e.g., any suitable NF shown in FIG. 6, shown in FIG. 3, or otherwise described in this disclosure).

In step 4, as shown in FIG. 6, after the TRF (and/or other suitable NF) has completed processing the UE request for a service update, the TRF sends a response message to the 6G-AN, which sends the response message to the UE. For example, the response message may indicate whether the UE service update request was successfully completed. The response message may also include other information that is relevant to the UE.

FIG. 7 is a flow diagram of an illustrative method 700 for a UE-initiated policy request, in accordance with some embodiments of this disclosure. In method 700, the 6G-AN receives, from the UE, the UE temporary ID (e.g., as may have been generated using method 400) along with the information related to the ID of the NF (e.g., the instance of the NF) that the UE wants to interact with (e.g., to support the policy update request).

In step 1, as shown in FIG. 7, the 6G-AN receives a message from the UE for supporting the UE to interact with the 6GS. In this illustrative method 700, the UE wants to obtain, update, or negotiate policies related to AM. For example, the 6G-AN may route the message to the PCF (e.g., a particular PCF instance) that serves the AM policies for the UE. The UE includes AN parameters in the message sent to the 6G-AN. The AN parameters include the UE temporary ID, and may also include a NF ID (e.g., a PCF ID), to indicate to the 6G-AN which network function the message needs to be forwarded to.

In step 2a, as shown in FIG. 7, the 6G-AN validates the UE temporary ID and determines the ID(s) of at least one network function that is associated with (or otherwise provides support based on) the UE temporary ID. For example, the 6G-AN determines IDs of RMF, TRF, UCF, AAF and/or PCF (or any other suitable NF shown in FIG. 7, shown in FIG. 3, or otherwise described in this disclosure) that support the UE based on the temporary ID. If the UE, in the message received at step 1 as shown in FIG. 7, provided an ID of the network function for which the message is intended, the 6G-AN may be configured to verify whether the ID provided by the UE (e.g., the PCF ID, and/or any other suitable NF ID) matches (or is otherwise associated with) the PCF ID that is associated with the UE temporary ID. Alternatively, or in addition, the 6G-AN may be configured to interact with other network functions (e.g., UCF, AAF, PCF, any other suitable NF, or any combination thereof) with which the UE is associated to verify whether the UE is authorized to interact with the PCF ID.

In step 2b, as shown in FIG. 7, after the validation is successful, the 6G-AN determines to route the UE message to the proper NF (e.g., a PCF, as shown, and/or any other suitable NF).

In step 3, as shown in FIG. 7, the PCF processes the UE request to update a policy (e.g., an AM policy, and/or any other suitable UE policy).

In step 4, as shown in FIG. 7, the 6G-AN receives a response message from the PCF and forwards the response message to the UE. The response message may provide a status of the UE request, or information relevant to the UE request. For example, the response message may indicate that the request has been successfully processed.

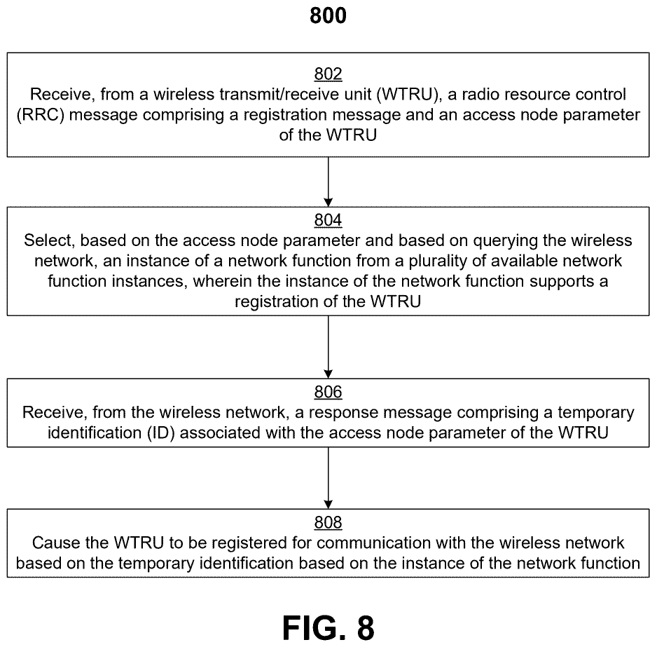

FIG. 8 is a flow diagram of an illustrative method 800 for registering a UE to communicate with a wireless network using a node of the wireless network, in accordance with some embodiments of this disclosure. In certain representative embodiments, method 800 may correspond to operations of method 400, as further described below. In certain representative embodiments, method 800 may be extended to include the operations of method 500, method 600, method 700, or any combination thereof.

In certain representative embodiments, method 800 is performed by a RAN node (e.g., a node of RAN 104/113, RAN node 200, a node of RAN 303, or any 6G-AN as shown and described in connection with FIGS. 4-7). That RAN node is typically in communication with a WTRU (e.g., any WTRU 102, UE 302, or any UE as shown and described in connection with FIGS. 4-7).

At step 802, the RAN node receives, from a wireless transmit/receive unit (WTRU), a RRC message including a registration message and an access node parameter of the WTRU.

For example, step 802 may correspond to step 1 of FIG. 4A. The RRC message could include the registration message as a NAS message. The UE may be configured to send the message that is received step 802 to initiate an initial registration procedure. The access node parameter could be any one or more of a public land mobile network identification (PLMN ID), a subscription concealed identifier (SUCI), a routing indicator, an RRC connection setup procedure establishment clause, a message type field, or a service type field.

At step 804, the RAN node selects, based on the access node parameter and based on querying the wireless network, an instance of a network function (e.g., a network function ID) from multiple available network function instances, wherein the instance of the network function supports a registration of the WTRU. Step 804 can also include selecting the network function from multiple available network functions, where the multiple available network functions may include any two or more of the functions shown in FIGS. 3-7 or otherwise described in this disclosure.

For example, step 804 may correspond to step 2f of FIG. 4A. In certain representative embodiments, step 804 may further include querying and receiving a reply from a DNS server (e.g., corresponding to steps 2b and 2c of FIG. 4A), querying and receiving a reply from an NRF (e.g., corresponding to steps 2d and 2e of FIG. 4A), or both. That is, querying the wireless network may include querying a DNS server and/or an NRF. If step 804 includes selecting the network function from multiple available network functions, then step 804 may further correspond to step 2a of FIG. 4A.

At step 806, the RAN node receives, from the wireless network (e.g., from a UCF), a response message including a temporary identification (ID) associated with the access node parameter of the WTRU. The temporary ID may be a 6g-GUTI, and associating the temporary ID with the access node parameter of the WTRU may include associating the temporary ID with a UE context or another ID of the UE.

For example, step 806 may correspond to step 4c of FIG. 4B. In certain representative embodiments, step 806 further includes causing the UCF to allocate the temporary ID to the UE (e.g., as shown and described in connection with step 4b of FIG. 4B) based on sending a request to the UCF to create the UE context (e.g., as shown and described in connection with step 4a of FIG. 4B).

At step 808, the RAN node causes the WTRU to be registered for communication with the wireless network based on the temporary identification and based on the instance of the network function. That is, at step 808, the RAN node may provide a registration accept message indicating that the initial UE registration has been successfully completed.

For example, step 808 may correspond to step 7 of FIG. 4B. In certain representative embodiments, step 808 further includes sending a registration request to an RMF (e.g., as shown and described in connection with step 5a of FIG. 4B), causing the RMF to obtain UE subscription data from the UDM (e.g., as shown and described in connection with step 5b of FIG. 4B), causing the RMF to request that the UCF updates the UE context based on the subscription data obtained from the UDM (e.g., as shown and described in connection with step 5c of FIG. 4B), causing the RMF to select a PCF policy (e.g., as shown and described in connection with step 6a of FIG. 4B), and causing the RMF to send a message to the UCF requesting that a PCF ID (e.g., associated with that PCF policy selected by the RMF) to be associated with the UE context (e.g., as shown and described in connection with step 6b of FIG. 4B).

Throughout the specification the phrases “in response to” and “based on” shall be understood to have a broad meaning unless stated otherwise. For example, “in response to” can refer to a step that is in direct or indirect response to a prior step, and “based on” can refer to a step that is based at least in part on a prior step.

Although features and elements are provided above in particular combinations, one of ordinary skill in the art will appreciate that each feature or element can be used alone or in any combination with the other features and elements. The present disclosure is not to be limited in terms of the particular embodiments described in this application, which are intended as illustrations of various aspects. Many modifications and variations may be made without departing from its spirit and scope, as will be apparent to those skilled in the art. No element, act, or instruction used in the description of the present application should be construed as critical or essential to the invention unless explicitly provided as such. Functionally equivalent methods and apparatuses within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods or systems.

The foregoing embodiments are discussed, for simplicity, with regard to the terminology and structure of wireless communication capable devices, (e.g., radio wave emitters and receivers). However, the embodiments discussed are not limited to these systems but may be applied to other systems that use other forms of electromagnetic waves or non-electromagnetic waves such as acoustic waves.

It is also to be understood that the terminology used herein is for the purpose of describing particular embodiments only and is not intended to be limiting. As used herein, the term “video” or the term “imagery” may mean any of a snapshot, single image and/or multiple images displayed over a time basis. As another example, when referred to herein, the terms “user equipment” and its abbreviation “UE”, the term “remote” and/or the terms “head mounted display” or its abbreviation “HMD” may mean or include (i) a wireless transmit and/or receive unit (WTRU); (ii) any of a number of embodiments of a WTRU; (iii) a wireless-capable and/or wired-capable (e.g., tetherable) device configured with, inter alia, some or all structures and functionality of a WTRU; (iii) a wireless-capable and/or wired-capable device configured with less than all structures and functionality of a WTRU; or (iv) the like. Details of an example WTRU, which may be representative of any WTRU recited herein, are provided herein with respect to FIGS. 1A-1D. As another example, various disclosed embodiments herein supra and infra are described as utilizing a head mounted display. Those skilled in the art will recognize that a device other than the head mounted display may be utilized and some or all of the disclosure and various disclosed embodiments can be modified accordingly without undue experimentation. Examples of such other device may include a drone or other device configured to stream information for providing the adapted reality experience.

In addition, the methods provided herein may be implemented in a computer program, software, or firmware incorporated in a computer-readable medium for execution by a computer or processor. Examples of computer-readable media include electronic signals (transmitted over wired or wireless connections) and computer-readable storage media. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Variations of the method, apparatus and system provided above are possible without departing from the scope of the invention. In view of the wide variety of embodiments that can be applied, it should be understood that the illustrated embodiments are examples only and should not be taken as limiting the scope of the following claims. For instance, the embodiments provided herein include handheld devices, which may include or be utilized with any appropriate voltage source, such as a battery or the like, providing any appropriate voltage.

Moreover, in the embodiments provided above, processing platforms, computing systems, controllers, and other devices that include processors are noted. These devices may include at least one Central Processing Unit (“CPU”) and memory. In accordance with the practices of persons skilled in the art of computer programming, reference to acts and symbolic representations of operations or instructions may be performed by the various CPUs and memories. Such acts and operations or instructions may be referred to as being “executed,” “computer executed” or “CPU executed.”

One of ordinary skill in the art will appreciate that the acts and symbolically represented operations or instructions include the manipulation of electrical signals by the CPU. An electrical system represents data bits that can cause a resulting transformation or reduction of the electrical signals and the maintenance of data bits at memory locations in a memory system to thereby reconfigure or otherwise alter the CPU's operation, as well as other processing of signals. The memory locations where data bits are maintained are physical locations that have particular electrical, magnetic, optical, or organic properties corresponding to or representative of the data bits. It should be understood that the embodiments are not limited to the above-mentioned platforms or CPUs and that other platforms and CPUs may support the provided methods.

The data bits may also be maintained on a computer readable medium including magnetic disks, optical disks, and any other volatile (e.g., Random Access Memory (RAM)) or non-volatile (e.g., Read-Only Memory (ROM)) mass storage system readable by the CPU. The computer readable medium may include cooperating or interconnected computer readable medium, which exist exclusively on the processing system or are distributed among multiple interconnected processing systems that may be local or remote to the processing system. It should be understood that the embodiments are not limited to the above-mentioned memories and that other platforms and memories may support the provided methods.

In an illustrative embodiment, any of the operations, processes, etc. described herein may be implemented as computer-readable instructions stored on a computer-readable medium. The computer-readable instructions may be executed by a processor of a mobile unit, a network element, and/or any other computing device.

There is little distinction left between hardware and software implementations of aspects of systems. The use of hardware or software is generally (but not always, in that in certain contexts the choice between hardware and software may become significant) a design choice representing cost versus efficiency tradeoffs. There may be various vehicles by which processes and/or systems and/or other technologies described herein may be affected (e.g., hardware, software, and/or firmware), and the preferred vehicle may vary with the context in which the processes and/or systems and/or other technologies are deployed. For example, if an implementer determines that speed and accuracy are paramount, the implementer may opt for a mainly hardware and/or firmware vehicle. If flexibility is paramount, the implementer may opt for a mainly software implementation. Alternatively, the implementer may opt for some combination of hardware, software, and/or firmware.

The foregoing detailed description has set forth various embodiments of the devices and/or processes via the use of block diagrams, flowcharts, and/or examples. Insofar as such block diagrams, flowcharts, and/or examples include one or more functions and/or operations, it will be understood by those within the art that each function and/or operation within such block diagrams, flowcharts, or examples may be implemented, individually and/or collectively, by a wide range of hardware, software, firmware, or virtually any combination thereof. In an embodiment, several portions of the subject matter described herein may be implemented via Application Specific Integrated Circuits (ASICs), Field Programmable Gate Arrays (FPGAs), digital signal processors (DSPs), and/or other integrated formats. However, those skilled in the art will recognize that some aspects of the embodiments disclosed herein, in whole or in part, may be equivalently implemented in integrated circuits, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein may be distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type of medium such as a floppy disk, a hard disk drive, a CD, a DVD, a digital tape, a computer memory, etc., and a transmission type medium such as a digital and/or an analog communication medium (e.g., a fiber optic cable, a waveguide, a wired communications link, a wireless communication link, etc.).

Those skilled in the art will recognize that it is common within the art to describe devices and/or processes in the fashion set forth herein, and thereafter use engineering practices to integrate such described devices and/or processes into data processing systems. That is, at least a portion of the devices and/or processes described herein may be integrated into a data processing system via a reasonable amount of experimentation. Those having skill in the art will recognize that a typical data processing system may generally include one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity, control motors for moving and/or adjusting components and/or quantities). A typical data processing system may be implemented utilizing any suitable commercially available components, such as those typically found in data computing/communication and/or network computing/communication systems.

The herein described subject matter sometimes illustrates different components included within, or connected with, different other components. It is to be understood that such depicted architectures are merely examples, and that in fact many other architectures may be implemented which achieve the same functionality. In a conceptual sense, any arrangement of components to achieve the same functionality is effectively “associated” such that the desired functionality may be achieved. Hence, any two components herein combined to achieve a particular functionality may be seen as “associated with” each other such that the desired functionality is achieved, irrespective of architectures or intermedial components. Likewise, any two components so associated may also be viewed as being “operably connected”, or “operably coupled”, to each other to achieve the desired functionality, and any two components capable of being so associated may also be viewed as being “operably couplable” to each other to achieve the desired functionality. Specific examples of operably couplable include but are not limited to physically mateable and/or physically interacting components and/or wirelessly interactable and/or wirelessly interacting components and/or logically interacting and/or logically interactable components.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, where only one item is intended, the term “single” or similar language may be used. As an aid to understanding, the following appended claims and/or the descriptions herein may include usage of the introductory phrases “at least one” and “one or more” to introduce claim recitations. However, the use of such phrases should not be construed to imply that the introduction of a claim recitation by the indefinite articles “a” or “an” limits any particular claim including such introduced claim recitation to embodiments including only one such recitation, even when the same claim includes the introductory phrases “one or more” or “at least one” and indefinite articles such as “a” or “an” (e.g., “a” and/or “an” should be interpreted to mean “at least one” or “one or more”). The same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.” Further, the terms “any of” followed by a listing of a plurality of items and/or a plurality of categories of items, as used herein, are intended to include “any of,” “any combination of,” “any multiple of,” and/or “any combination of multiples of” the items and/or the categories of items, individually or in conjunction with other items and/or other categories of items. Moreover, as used herein, the term “set” is intended to include any number of items, including zero. Additionally, as used herein, the term “number” is intended to include any number, including zero. And the term “multiple”, as used herein, is intended to be synonymous with “a plurality”.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein may be readily broken down into a lower third, middle third and upper third, etc. As will also be understood by one skilled in the art all language such as “up to,” “at least,” “greater than,” “less than,” and the like includes the number recited and refers to ranges which can be subsequently broken down into subranges as discussed above. Finally, as will be understood by one skilled in the art, a range includes each individual member. Thus, for example, a group having 1-3 cells refers to groups having 1, 2, or 3 cells. Similarly, a group having 1-5 cells refers to groups having 1, 2, 3, 4, or 5 cells, and so forth.

Moreover, the claims should not be read as limited to the provided order or elements unless stated to that effect. In addition, use of the terms “means for” in any claim is intended to invoke 35 U.S.C. § 112, ¶ 6, 35 U.S.C. § 112(f) or means-plus-function claim format, and any claim without the terms “means for” is not so intended.

What is claimed is:

1. A method performed by a node of a wireless network, the method comprising:
receiving, from a wireless transmit/receive unit (WTRU), a radio resource control (RRC) message comprising a registration message and an access node parameter of the WTRU;
selecting, based on the access node parameter and based on querying the wireless network, an instance of a network function from a plurality of available network function instances, wherein the instance of the network function supports a registration of the WTRU;
receiving, from the wireless network, a response message comprising a temporary identification (ID) associated with the access node parameter of the WTRU; and
causing the WTRU to be registered for communication with the wireless network based on the temporary identification and based on the instance of the network function.

2. The method of claim 1, wherein the access node parameter comprises at least one of a public land mobile network identification (PLMN ID), a subscription concealed identifier (SUCI), a routing indicator, an RRC establishment clause, a message type field, or a service type field.

3. The method of claim 1, wherein querying the wireless network comprises communicating with at least one of a domain name system (DNS) server or a network repository function (NRF).

4. The method of claim 1, wherein the method further comprises selecting the network function from a plurality of available network functions, the plurality of available network functions comprising at least two of a registration and mobility management function (RMF), authentication and authorization function (AAF), unified context management function (UCF), and a tracking and reachability function (TRF).

5. The method of claim 1, where selecting the instance of the network function comprises receiving a fully qualified domain name (FQDN) or an IP address, wherein the FQDN or the IP address is associated with the instance of the network function.

6. The method of claim 1, wherein the temporary identification comprises a first value and a second value, the first value comprising a globally unique disaggregated access and management identifier (GUDAMI), and the second value comprising a randomly assigned value that can be used to identify the WTRU.

7. The method of claim 1, wherein the access node parameter comprises a public land mobile network identification (PLMN ID) and a subscription concealed identifier (SUCI), the method further comprising constructing a fully qualified domain name (FQDN), wherein querying the wireless network comprises providing the FQDN to a domain name system (DNS) server.

8. The method of claim 1, wherein receiving, from the wireless network, the response message comprises receiving the response message from a unified context management function (UCF) of the wireless network.

9. The method of claim 1, further comprising:
receiving an update request from the WTRU, the update request comprising the temporary identification;
associating the update request with the instance of the network function based on the temporary identification; and
causing the WTRU to update the registration.

10. The method of claim 9, wherein the update request comprises a registration update request, a service update request, or a policy update request.

11. A node of a wireless network comprising processing circuitry and communication circuitry, the node configured to:
receive, from a wireless transmit/receive unit (WTRU), a radio resource control (RRC) message comprising a registration message and an access node parameter of the WTRU;
select, based on the access node parameter and based on querying the wireless network, an instance of a network function from a plurality of available network function instances, wherein the instance of the network function supports a registration of the WTRU;
receive, from the wireless network, a response message comprising a temporary identification (ID) associated with the access node parameter of the WTRU; and
cause the WTRU to be registered for communication with the wireless network based on the temporary identification and based on the instance of the network function.

12. The node of claim 11, wherein the access node parameter comprises at least one of a public land mobile network identification (PLMN ID), a subscription concealed identifier (SUCI), a routing indicator, an RRC establishment clause, a message type field, or a service type field.

13. The node of claim 11, wherein querying the wireless network comprise communicating with at least one of a domain name system (DNS) server or a network repository function (NRF).

14. The node of claim 11, wherein the node is further configured to select the network function from a plurality of available network functions, the plurality of available network functions comprising at least two of a registration and mobility management function (RMF), authentication and authorization function (AAF), unified context management function (UCF), and a tracking and reachability function (TRF).

15. The node of claim 11, where to select the instance of the network function comprises receiving a fully qualified domain name (FQDN) or an IP address, wherein the FQDN or the IP address is associated with the instance of the network function.

16. The node of claim 11, wherein the temporary identification comprises a first value and a second value, the first value comprising a globally unique disaggregated access and management identifier (GUDAMI), and the second value comprising a randomly assigned value that can be used to identify the WTRU.

17. The node of claim 11, wherein the access node parameter comprises a public land mobile network identification (PLMN ID) and a subscription concealed identifier (SUCI), the node is further configured to construct a fully qualified domain name (FQDN), and querying the wireless network comprises providing the FQDN to a domain name system (DNS) server.

18. The node of claim 11, wherein to select the instance of the network function is further based on a validity that is indicated in response to the querying.

19. The node of claim 11, further configured to:
receive an update request from the WTRU, the update request comprising the temporary identification;
associate the update request with the instance of the network function based on the temporary identification; and
cause the WTRU to update the registration.

20. The node of claim 18, wherein the update request comprises a registration update request, a service update request, or a policy update request.
